(19) United States
(12) Patent Application Publication
(10) Pub. No.: US 2026/0189831 A1
(43) Pub. Date: Jul. 2, 2026

(54) AIR BLOWING UNIT AND VR APPARATUS

(71) Applicant: Murata Manufacturing Co., Ltd., Nagaokakyo-shi (JP)

(72) Inventor: Kenjiro OKAGUCHI, Nagaokakyo-shi (JP)

(21) Appl. No.: 19/546,528

(22) Filed: Feb. 23, 2026

Related U.S. Application Data
(63) Continuation of application No. PCT/JP2024/029235, filed on Aug. 19, 2024.

(30) Foreign Application Priority Data
Sep. 4, 2023 (JP) 2023-142814

(51) Int. Cl. H04R 1/02; G02B 27/01

(52) U.S. Cl. CPC H04R 1/028; G02B 27/0176

(57) ABSTRACT

An air blowing unit includes a housing having a first opening capable of communicating with an ear canal opening of a user, an air blowing device that is provided in the housing and generates a gas to be delivered from the first opening to the outside of the housing, and a speaker that is provided in the housing and generates sound to be delivered from the first opening to the outside of the housing. A discharge port of the air blowing device is disposed at a position overlapping the first opening when the first opening is viewed from the outside. The speaker is disposed at a position that is present on the first opening side relative to the air blowing device and does not overlap the discharge port as viewed from the outer side of the first opening.

### CROSS REFERENCE TO RELATED APPLICATION

This is a continuation of International Application No. PCT/JP2024/029235 filed on August 19, 2024 which claims priority from Japanese Patent Application No. 2023-142814 filed on September 4, 2023. The contents of these applications are incorporated herein by reference in their entireties.

### BACKGROUND OF THE DISCLOSURE

### Field of the Disclosure

The present disclosure relates to an air blowing unit that includes a sound radiation function and an air blowing function and is wearable on a user's head.

### Description of the Related Art

An ear-applied unit is described in Japanese Unexamined Patent Application Publication No. 2014-68831. The ear-applied unit of Japanese Unexamined Patent Application Publication No. 2014-68831 includes an arm and main body portions. The main body portions are disposed so as to cover the auricles of a user.

The main body portion includes a heating element and a fan. Heat generated by the heating element is propagated to the inside of a user's ear by the fan. This allows the ear-applied unit to warm the inside of the user's ear.

### BRIEF SUMMARY OF THE DISCLOSURE

In a unit that is applied to a user's auricle and blows air into the inside of the ear like that shown in Japanese Unexamined Patent Application Publication No. 2014-68831, a sound radiation function is sometimes desired.

However, it has not been easy to achieve both air blowing performance and sound radiation performance with such a shape as to be worn on a user's ear.

Accordingly, a possible benefit of the present disclosure is to provide an air blowing unit that is provided with a speaker and achieves both air blowing performance and sound radiation performance with such a shape as to be wearable on a user’s ear.

An air blowing unit of this disclosure includes a housing having a first opening capable of communicating with an ear canal opening of a user, an air blowing device that is provided in the housing and generates a gas to be delivered from the first opening to the outside of the housing, and a speaker that is provided in the housing and generates sound to be delivered from the first opening to the outside of the housing.

A discharge port of the air blowing device is disposed at a position overlapping the first opening when the first opening is viewed from the outside. The speaker is disposed at a position that is present on the first opening side relative to the air blowing device and does not overlap the discharge port as viewed from the outer side of the first opening. A main sound radiation direction of the speaker is a direction different from a direction connecting the position of the speaker and the first opening.

In this configuration, the gas discharged from the air blowing device is guided directly (without any obstruction) to the first opening, and is delivered from the first opening with low loss. The sound is less likely to cause turbulence as in an air current, and the sound radiated by the speaker is guided to the first opening while being reflected, and is radiated from the first opening. Thus, it is possible to allow the user to hear the sound from the speaker while implementing efficient and effective air blowing.

According to this disclosure, it is possible to achieve both air blowing performance and sound radiation performance with such a shape as to be wearable on a user's ear.

### BRIEF DESCRIPTION OF THE SEVERAL VIEWS OF THE DRAWINGS

FIG. 1 is a side cross-sectional view depicting an example of a configuration of an air blowing unit according to a first embodiment.

FIG. 2 is a side cross-sectional view depicting an example of a configuration of an air blowing device.

FIG. 3A is a perspective view depicting an example of how the air blowing unit according to the first embodiment is worn; and FIG. 3B is an enlarged cross-sectional view of a vicinity of a wearing position.

FIG. 4 is a graph depicting an example of acoustic frequency characteristics of a piezoelectric pump and a motor (axial flow fan).

FIG. 5 is a functional block diagram depicting an example of a configuration of the air blowing unit according to the first embodiment.

FIG. 6 is a side cross-sectional view depicting an example of a configuration of an air blowing unit according to a second embodiment.

FIG. 7A is a perspective view depicting an example of how the air blowing unit according to the second embodiment is worn; and FIG. 7B is an enlarged cross-sectional view of a vicinity of a wearing position.

FIG. 8 is a functional block diagram of the air blowing unit according to the second embodiment.

FIG. 9 is a side cross-sectional view depicting an example of a configuration of an air blowing unit according to a third embodiment.

FIG. 10 is a functional block diagram of the air blowing unit according to the third embodiment.

FIG. 11 is a schematic configuration diagram of a temperature sensor of an air blowing unit according to a fourth embodiment.

FIG. 12 is an enlarged cross-sectional view of a vicinity of a wearing position of the air blowing unit according to the fourth embodiment.

FIG. 13A is a circuit diagram depicting an example of an activation circuit of an air blowing control section; and FIG. 13B depicts an output voltage characteristic of the activation circuit.

FIG. 14 is a circuit diagram depicting an example of a drive circuit of the air blowing control section.

FIG. 15 is a functional block diagram of a VR apparatus using an air blowing unit.

FIG. 16 is a diagram depicting an example of how the VR apparatus is worn.

FIG. 17 is a side cross-sectional view depicting an example of a configuration of a headphone-type air blowing unit.

FIG. 18 is a diagram depicting an example of how the headphone-type air blowing unit is worn.

FIG. 19 is a side cross-sectional view depicting an example of a configuration of a headphone-type air blowing unit.

### DETAILED DESCRIPTION OF THE DISCLOSURE

### FIRST EMBODIMENT

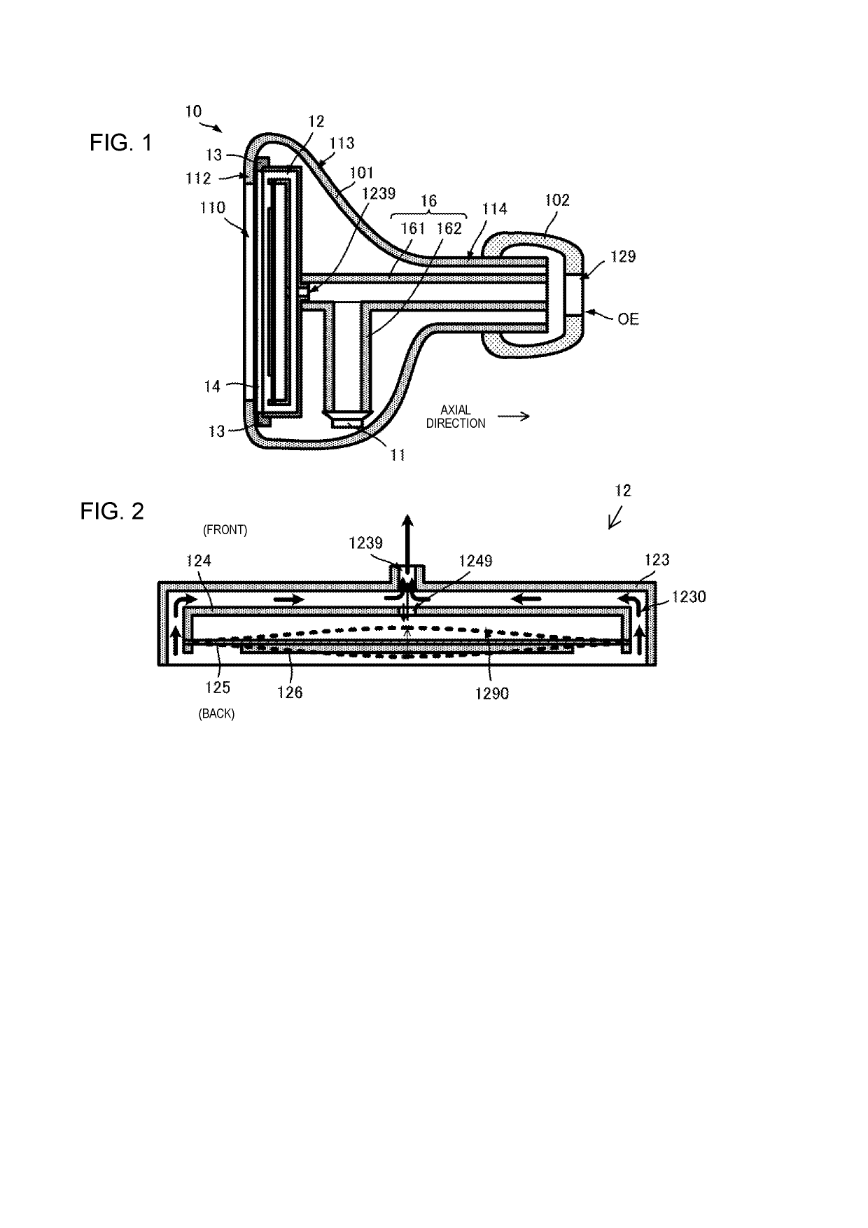

An air blowing unit according to a first embodiment of the present disclosure is described with reference to the drawings. FIG. 1 is a side cross-sectional view depicting an example of a configuration of the air blowing unit according to the first embodiment.

As depicted in FIG. 1, an air blowing unit 10 includes a housing 101, a speaker 11, an air blowing device 12, a first sound absorbing member 13, a second sound absorbing member 14, a flow passage tube 16, and an ear pad 102. The fixing member of the disclosure of the present application is configured by the first sound absorbing member 13 and the second sound absorbing member 14.

The housing 101 includes a bottom wall 112, a side wall 113, and a cylindrical portion 114.

The bottom wall 112 is a substantially flat plate. The side wall 113 is erected along the outer periphery of the bottom wall 112. The side wall 113 has a shape in which, in a direction orthogonal to the flat plate surface of the bottom wall 112, the area of a cross-section parallel to the flat plate surface of the bottom wall 112 becomes smaller as the position of the cross-section becomes farther from the bottom wall 112.

The cross-sectional area of an opening of the cylindrical portion 114 is smaller than the area of the flat plate surface of the bottom wall 112. The cylindrical portion 114 is connected to an end portion of the side wall 113 on the side opposite to an end portion connected to the bottom wall 112. An internal space of the cylindrical portion 114 communicates with an internal space surrounded by the bottom wall 112 and the side wall 113. Further, these internal spaces form an internal space of the housing 101.

The housing 101 is composed of a material having rigidity that allows the shape to be kept constant, and is composed of, for example, a resin, a metal, or the like.

The ear pad 102 has an annular shape. The ear pad 102 is composed of a material having cushioning properties.

The ear pad 102 has a central space 129. The ear pad 102 is attached to the housing 101 such that the cylindrical portion 114 of the housing 101 is inserted into the central space 129. Thus, the internal space of the housing 101 and the central space 129 of the ear pad 102 communicate with each other. The opening surface of the ear pad 102 on the side opposite to the mounting surface to the housing 101 is an opening OE of the air blowing unit 10. The opening OE serves as a sound radiation surface and an airflow delivery surface as the air blowing unit 10.

The air blowing device 12 is configured with a piezoelectric pump. FIG. 2 is a side cross-sectional view depicting an example of a configuration of the air blowing device.

As depicted in FIG. 2, the air blowing device 12 includes an outer housing 123, an inner housing 124, a diaphragm 125, and a piezoelectric element 126.

The outer housing 123 has a rectangular shape in a front view, and has a discharge port 1239 penetrating a front wall at the center of the front wall. The back side of the outer housing 123 is open.

The inner housing 124 has a rectangular shape in a front view, and has a through-hole 1249 penetrating a front wall at the center of the front wall. The back side of the inner housing 124 is open. The shape of the inner housing 124 is smaller than that of the outer housing 123, and is approximately similar thereto.

The inner housing 124 is disposed in an internal space of the outer housing 123. The front direction of the inner housing 124 is the same as that of the outer housing. A flow passage 1230 is formed by a space surrounded by the outer housing 123 and the inner housing 124. When the air blowing device 12 is viewed from the front, the discharge port 1239 of the outer housing 123 and the through-hole 1249 of the inner housing 124 overlap each other.

The diaphragm 125 as a flat plate is disposed on the back side of the inner housing 124. The diaphragm 125 closes the opening of the inner housing 124 on the back side. Thus, in the air blowing device 12, a pump chamber 1290 surrounded by the inner housing 124 and the diaphragm 125 is formed.

The piezoelectric element 126 is disposed on the diaphragm 125.

By applying a drive signal of a predetermined frequency (drive frequency) to the piezoelectric element 126, the piezoelectric element 126 is deformed and the diaphragm 125 vibrates. Thus, the air blowing device 12 changes the volume of the pump chamber 1290. The air blowing device 12 utilizes this volume change to draw air from the back side of the air blowing device 12 into the pump chamber 1290 through the flow passage 1230 and the through-hole 1249. Further, when discharging air from the pump chamber 1290 through the through-hole 1249, the air blowing device 12 entrains air flowing in from the flow passage 1230 and discharges the air from the discharge port 1239.

Thus, the air blowing device 12 has high directivity in the front direction, and discharges a gas at a predetermined flow velocity.

The air blowing device 12 having such a configuration is disposed such that the wall on the front side is substantially orthogonal to the axial direction of the housing 101 and the discharge port 1239 is oriented toward the opening OE.

The first sound absorbing member 13 is composed of a material having low air permeability and high sound absorbing properties. The first sound absorbing member 13 has an annular shape.

The first sound absorbing member 13 is disposed on the bottom wall 112 side of the housing 101 relative to the air blowing device 12. In other words, the first sound absorbing member 13 is disposed on the side opposite to the opening OE with the air blowing device 12 being a reference in the housing 101.

The first sound absorbing member 13 abuts against the bottom wall 112. A surface of the first sound absorbing member 13 on the side opposite to the bottom wall 112 abuts against the air blowing device 12.

The second sound absorbing member 14 is disposed in a through-hole penetrating the first sound absorbing member 13. The second sound absorbing member 14 overlaps the opening 110 of the bottom wall 112 of the air blowing unit 10.

The second sound absorbing member 14 is composed of a material having high air permeability and sound absorbing properties. The second sound absorbing member 14 is composed of, for example, glass wool, steel wool, or the like.

By including the first sound absorbing member 13 and the second sound absorbing member 14, the air blowing unit 10 can suppress leakage of undesired sound generated by the air blowing device 12 to the outside of the housing 101. Further, by including the second sound absorbing member 14, the air blowing unit 10 can ensure air supply to the air blowing device 12 while suppressing leakage of the above undesired sound.

That is, the first sound absorbing member 13 primarily implements absorption of undesired sound, and the second sound absorbing member 14 ensures air supply to the air blowing device 12 while assisting in absorbing undesired sound.

The speaker 11 is fixed to the housing 101. The speaker 11 is disposed such that a sound radiation surface thereof faces the internal space of the housing 101 and is exposed to this internal space.

A main sound radiation direction of the speaker 11 is orthogonal to the axial direction of the housing 101. The manner in which the speaker 11 is disposed is not limited thereto. As long as the speaker 11 does not overlap the discharge port 1239 of the air blowing device 12 as viewed from the opening OE, the disposition manner thereof is not limited thereto. Various manners, as appropriate, can be adopted for the manner in which the speaker 11 is disposed, depending on the shape of the flow passage tube 16.

The shape of the speaker 11 is not limited, but the speaker 11 may be as small as possible.

The flow passage tube 16 includes a first tube 161 and a second tube 162.

The first tube 161 has a shape extending in a direction parallel to the axial direction of the housing 101. One open end of the first tube 161 is connected to the discharge port 1239 of the air blowing device 12. The other open end of the first tube 161 is disposed in the vicinity of the opening OE of the air blowing unit 10. In plan view of the opening OE, the other open end of the first tube 161 overlaps the opening OE.

The second tube 162 has a shape extending in a direction orthogonal to the axial direction of the housing 101. One open end of the second tube 162 is connected to an intermediate position on the first tube 161 in the extension direction of the first tube 161. Thus, an internal space of the second tube 162 communicates with an internal space of the first tube 161. The other open end of the second tube 162 abuts against or is close to the sound radiation surface of the speaker 11. In plan view of the sound radiation surface, the opening portion (the internal space of the second tube 162) of the other open end overlaps the sound radiation surface.

With such a configuration, airflow discharged from the air blowing device 12 passes through the first tube 161, and directly reaches the opening OE to be delivered from the opening OE. Sound radiated from the speaker 11 propagates through the second tube 162 to the first tube 161, and is radiated from the opening OE through the first tube 161.

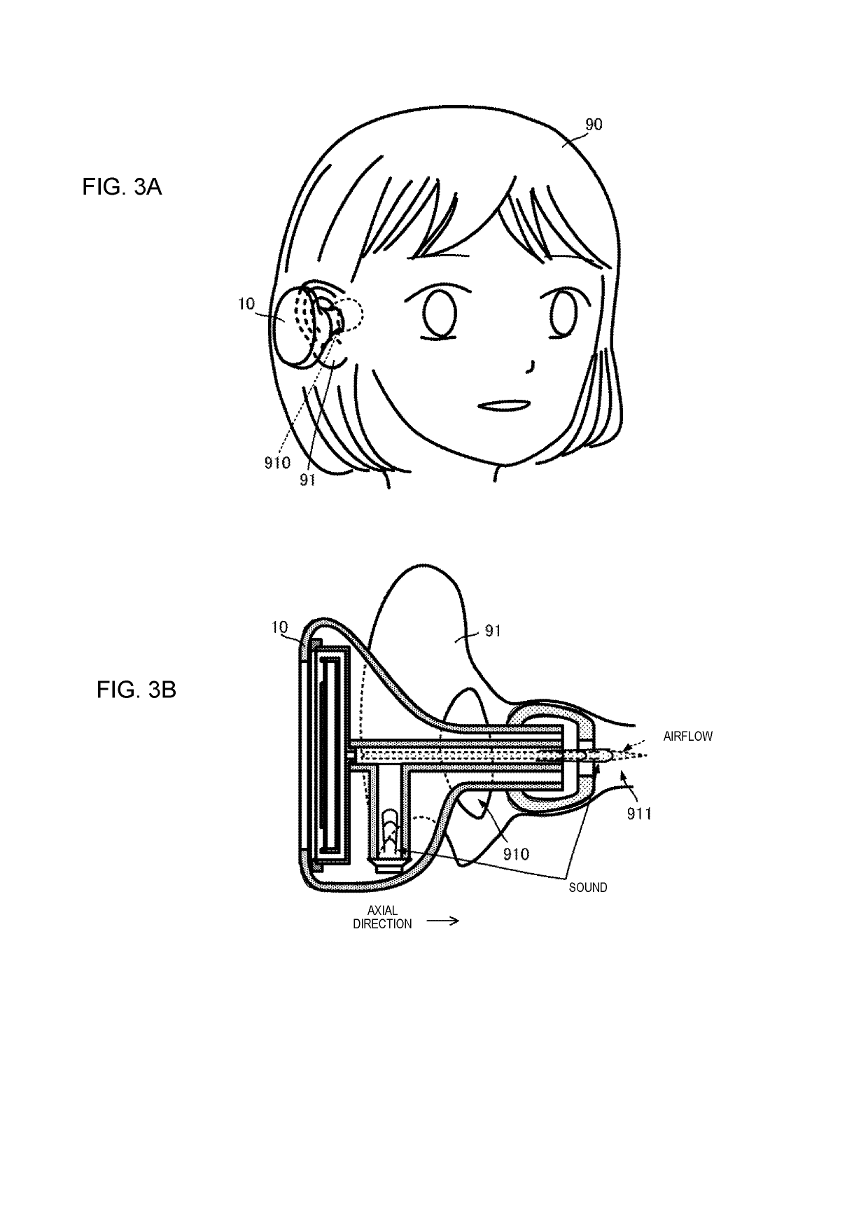

FIG. 3A is a perspective view depicting an example of how the air blowing unit according to the first embodiment is worn. FIG. 3B is an enlarged cross-sectional view of a vicinity of a wearing position.

As depicted in FIGS. 3A and 3B, the air blowing unit 10 is worn on a user 90 so as to be inserted into an ear canal opening 910 of an ear 91 of the user 90. That is, the air blowing unit 10 is an inner-type earphone.

In this worn state, airflow (gas) and sound delivered from the air blowing unit 10 are directly applied from the opening OE of the air blowing unit 10 to the ear canal opening 910 of the ear 91 of the user 90. The airflow and the sound enter an external auditory canal 911 through the ear canal opening 910. The airflow and the sound that have entered the external auditory canal 911 reach an eardrum.

Thus, the external auditory canal 911 and the eardrum of the user 90 are directly cooled, and the user 90 can hear the sound.

In particular, the vicinity of the eardrum is at a temperature close to the core temperature of a person. Accordingly, the air blowing unit 10 can provide a higher cooling effect by airflow than when airflow is applied to a region where skin is exposed, such as an arm, a face, or a leg. Further, because the air blowing unit 10 applies airflow to the user 90 from a position very close to the user 90, a high cooling effect can be obtained even with a low airflow volume.

Further, in the air blowing unit 10, airflow that is discharged from the air blowing device 12 configured with the piezoelectric pump and has high directivity is directly delivered from the opening OE. Thus, the air blowing unit 10 can deliver the airflow efficiently and effectively to the ear canal opening 910, the external auditory canal 911, and the eardrum of the user 90.

In addition, sound radiated from the speaker 11 does not have strong directivity. That is, the sound does not cause turbulence as in air, and thus, for example, is transmitted to the opening OE with substantially low loss while being reflected by an inner wall surface also inside the flow passage tube 16. Thus, the air blowing unit 10 can radiate sound to the eardrum of the user 90 with low loss.

On the other hand, for example, when the positional relationship between the air blowing device 12 and the speaker 11 is reversed, sound from the speaker 11 is directly radiated from the opening OE, but air (air current) discharged from the air blowing device 12 is likely to cause, for example, turbulence or the like inside the flow passage tube 16 and tends to incur loss.

As described above, the air blowing unit 10 can deliver airflow and sound to the ear canal opening 910 of the user 90 efficiently and effectively. Thus, the air blowing unit 10 can achieve both air blowing performance and sound radiation performance with such a shape as to be wearable on a user's ear.

Further, with this configuration, the air blowing unit 10 allows enhancement in flexibility in the arrangement position and arrangement orientation of the speaker 11 in the housing 101. Accordingly, the air blowing unit 10 allows the speaker 11 to be disposed in accordance with the shape of the housing 101, and can achieve size reduction of the housing 101, improvement in design, and the like.

Further, in the air blowing unit 10, a piezoelectric pump is used as the air blowing device 12. Thus, the following effect can be obtained.

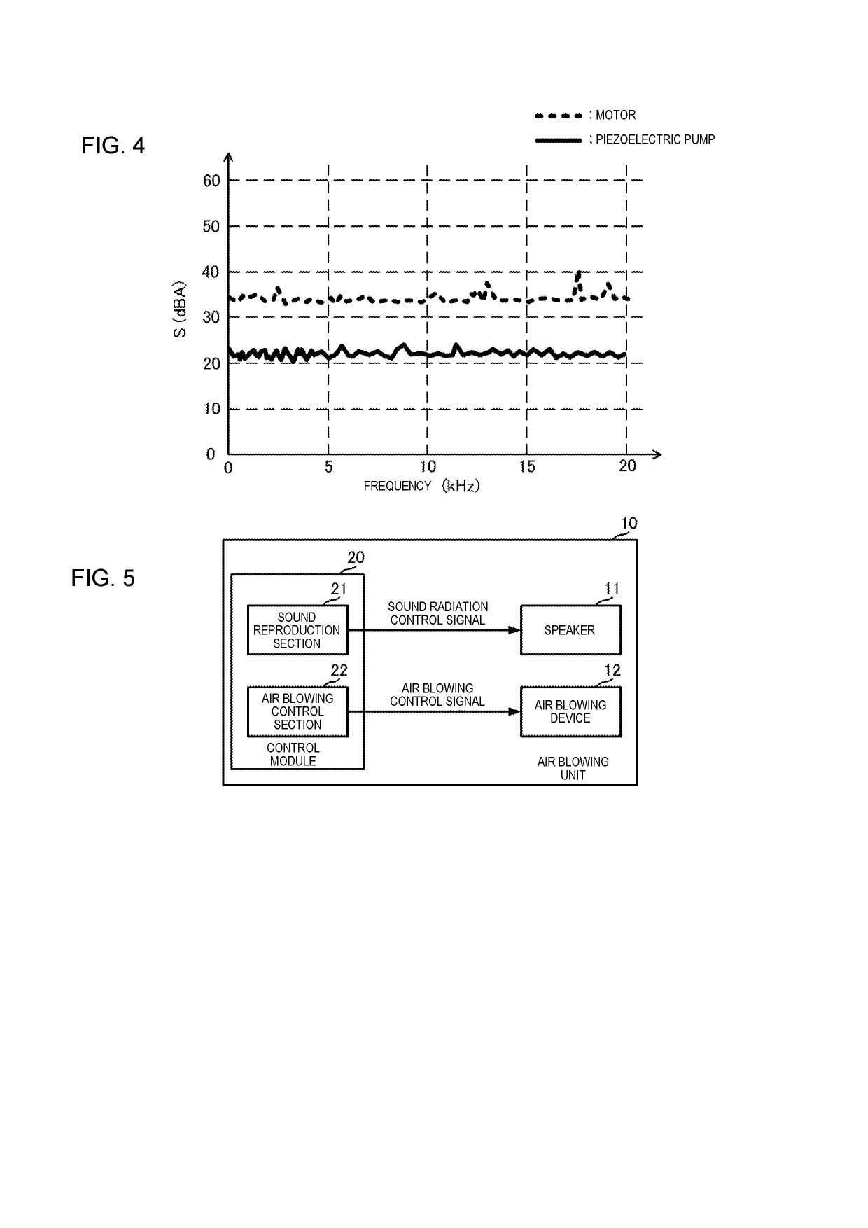

FIG. 4 is a graph depicting an example of acoustic frequency characteristics of the piezoelectric pump and a motor (axial flow fan). FIG. 4 indicates the audible range. In FIG. 4, the horizontal axis indicates the frequency and the vertical axis indicates the sound level, with a solid line representing the piezoelectric pump and a dotted line representing the motor (axial flow fan).

As depicted in FIG. 4, the use of the piezoelectric pump can suppress the sound level in the audible range.

As described above, the air blowing unit 10 can suppress noise perceived by the user 90.

Further, the piezoelectric pump is smaller, thinner, and lighter than the axial flow fan. Accordingly, the air blowing unit can achieve size reduction, thickness reduction, and weight reduction, and the load on the user 90 when the user 90 wears the air blowing unit 10 can be reduced.

In the flow passage tube 16, the flow passage cross-sectional area of the first tube 161 and the flow passage cross-sectional area of the second tube 162 may be the same or may be different. For example, by making the flow passage cross-sectional area of the second tube 162 smaller than that of the first tube 161, leakage of the gas (airflow) discharged from the air blowing device 12 toward the speaker 11 side can be suppressed.

### Functional Blocks of Air Blowing Unit 10

FIG. 5 is a functional block diagram depicting an example of a configuration of the air blowing unit according to the first embodiment. The air blowing unit 10 includes the speaker 11, the air blowing device 12, and a control module 20. The control module 20 includes a sound reproduction section 21 and an air blowing control section 22.

The control module 20 is configured by, for example, an IC, an electronic circuit module, or the like. Although depiction is omitted, the control module 20 is disposed at a position other than the flow passage tube 16 in the housing 101.

The control module 20 has a communication function or the like that is not depicted, or is connected to a signal cable, and music data, voice data, or the like to be reproduced by the speaker 11 is inputted to the control module 20. Further, an air blowing trigger that sets turning-on/off of air blowing is inputted to the control module 20.

The sound reproduction section 21 generates a sound radiation control signal on the basis of the music data, the voice data, or the like, and outputs the signal to the speaker 11.

The air blowing control section 22 generates an air blowing control signal to start air blowing by a trigger for turning on air blowing, and outputs the signal to the air blowing device 12. The air blowing control section 22 generates the air blowing control signal to stop air blowing by a trigger for turning off air blowing, and outputs the signal to the air blowing device 12.

If the air blowing trigger is associated with the music data or the voice data, it is also possible for the sound reproduction section 21 and the air blowing control section 22 to output the sound radiation control signal and the air blowing control signal in time synchronization by using this association information.

Further, it is also possible to provide an auxiliary sound for sound radiated by the speaker 11 by setting the frequency of the gas (airflow) discharged by the air blowing device 12 (the drive frequency of the piezoelectric pump) within the audible range.

### SECOND EMBODIMENT

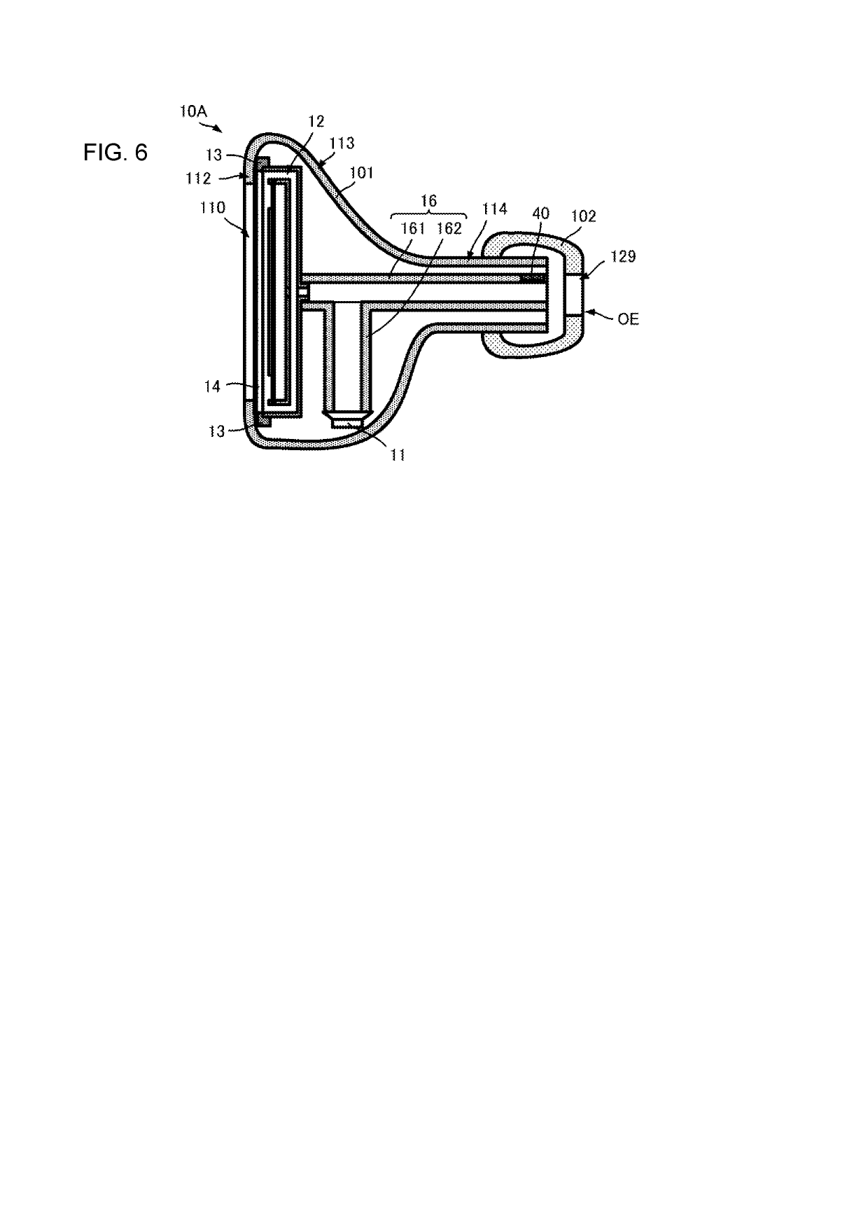

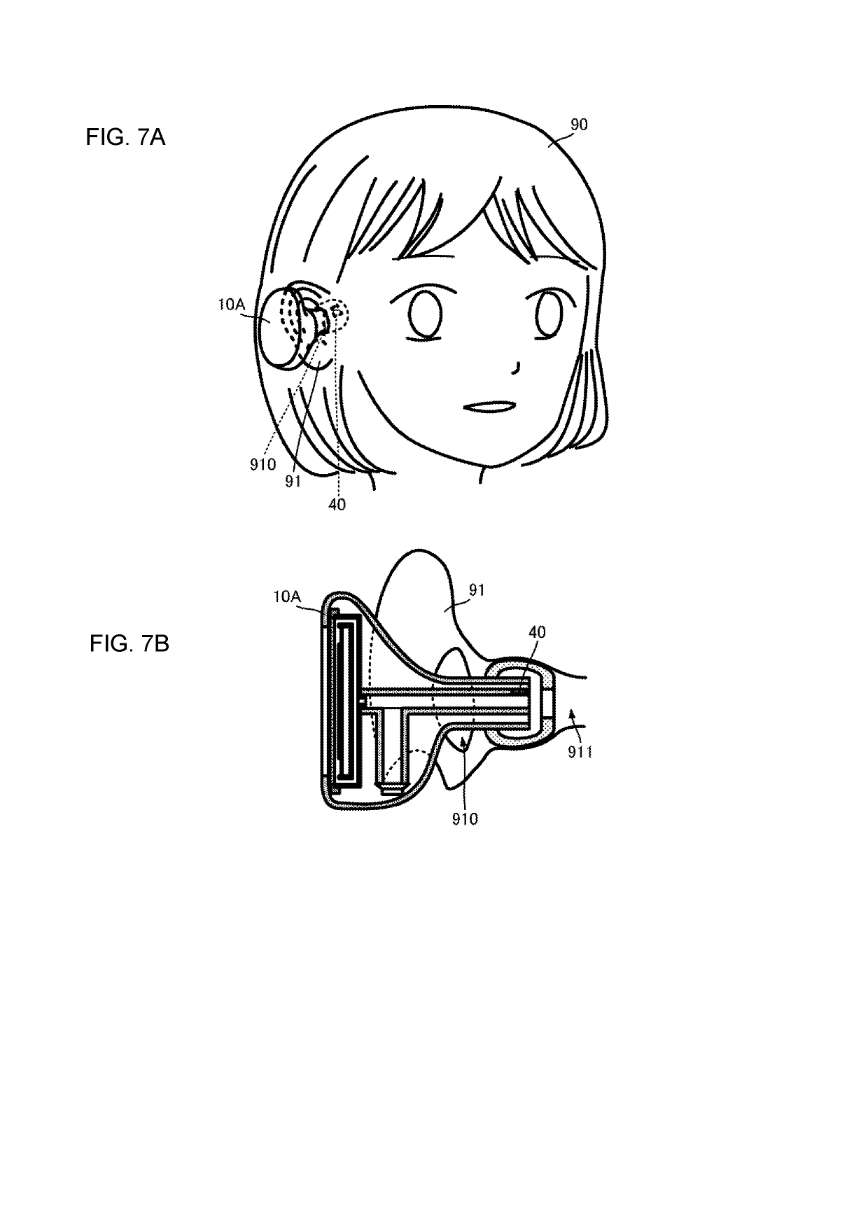

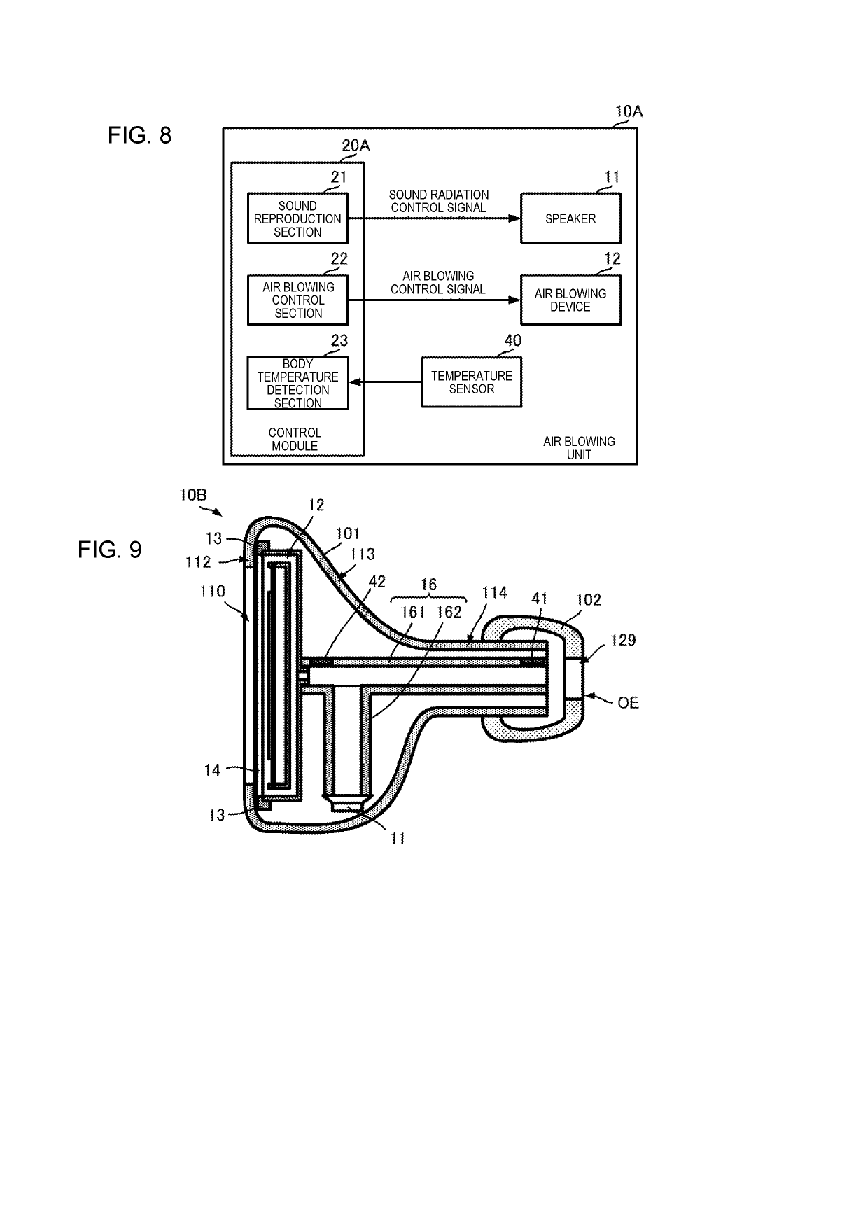

An air blowing unit according to a second embodiment of the present disclosure is described with reference to the drawings. FIG. 6 is a side cross-sectional view depicting an example of a configuration of the air blowing unit according to the second embodiment. FIG. 7A is a perspective view depicting an example of how the air blowing unit according to the second embodiment is worn. FIG. 7B is an enlarged cross-sectional view of a vicinity of a wearing position. FIG. 8 is a functional block diagram of the air blowing unit according to the second embodiment.

As depicted in FIGS. 6, 7A, 7B, and 8, an air blowing unit 10A according to the second embodiment is different from the air blowing unit 10 according to the first embodiment in that the air blowing unit 10A includes a control module 20A and a temperature sensor 40. The other configuration of the air blowing unit 10A is the same as that of the air blowing unit 10, and description of the same portions is omitted.

The air blowing unit 10A includes the control module 20A and the temperature sensor 40. The temperature sensor 40 is, for example, a chip-type thermistor. The temperature sensor 40 is disposed in or on the first tube 161 of the flow passage tube 16 of the air blowing unit 10A. The temperature sensor 40 may be disposed at a position near the tip of the first tube 161. The tip of the first tube 161 is the end on the side opposite to the side connected to the air blowing device 12 and on the side closer to the opening OE of the air blowing unit 10A. The temperature sensor 40 may be disposed at the tip of the cylindrical portion 114 of the housing 101, or may be disposed in or on the ear pad 102.

In such a configuration, when the user 90 wears the air blowing unit 10A, the temperature sensor 40 is disposed inside the ear canal opening 910, as depicted in FIGS. 7A and 7B. Thus, the temperature sensor 40 can detect the body temperature of the user 90 with high accuracy.

As depicted in FIG. 8, the temperature sensor 40 outputs a temperature detection signal based on the body temperature to the control module 20A.

The control module 20A includes a body temperature detection section 23. The body temperature detection section 23 detects the body temperature on the basis of the temperature detection signal. The air blowing control section 22 generates and outputs the air blowing control signal on the basis of the body temperature. For example, when detecting that the detected body temperature is greater than or equal to a threshold for cooling, the air blowing control section 22 generates the air blowing control signal and outputs it to the air blowing device 12.

Thus, the air blowing unit 10A can cool the user 90 by blowing air when the body temperature of the user 90 becomes high. At this time, the air blowing device 12 delivers airflow to the ear canal opening 910 and thus can effectively cool the user 90.

### THIRD EMBODIMENT

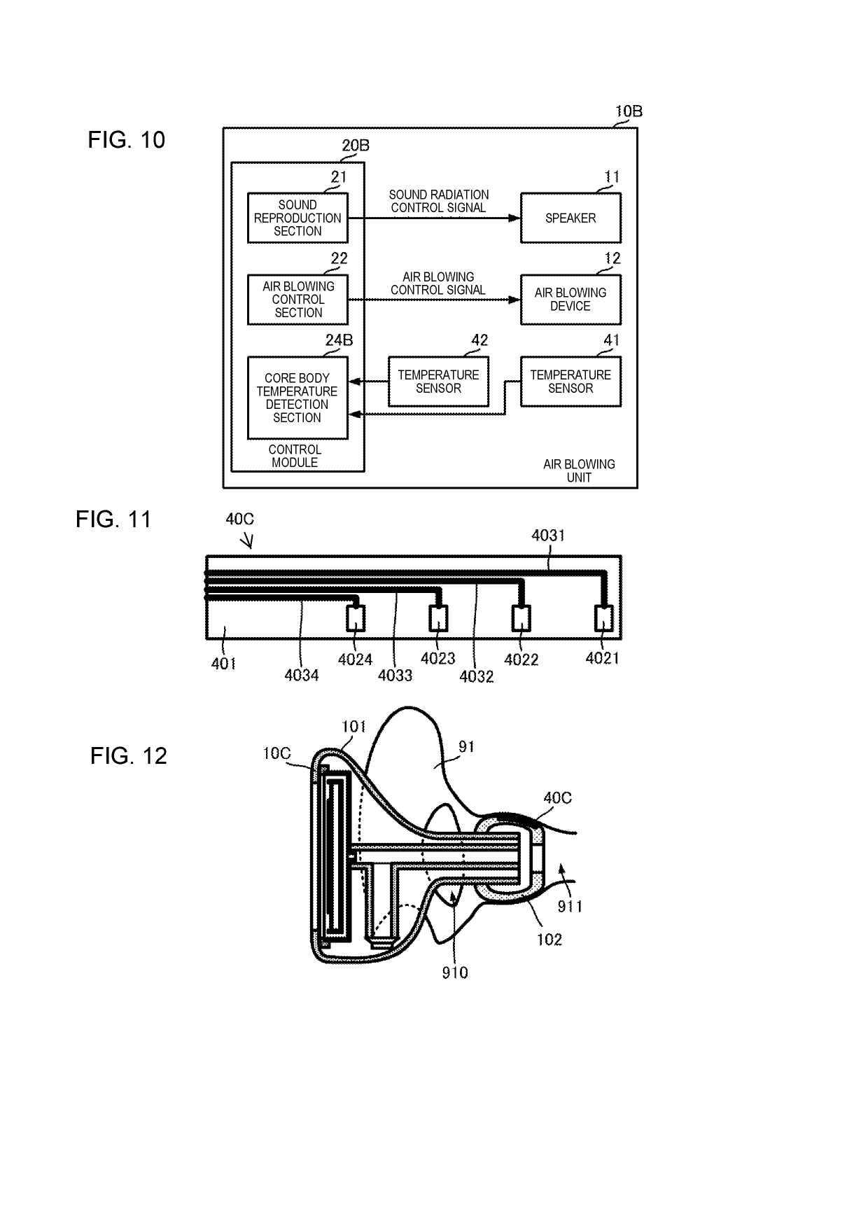

An air blowing unit according to a third embodiment of the present disclosure is described with reference to the drawings. FIG. 9 is a side cross-sectional view depicting an example of a configuration of the air blowing unit according to the third embodiment. FIG. 10 is a functional block diagram of the air blowing unit according to the third embodiment.

As depicted in FIGS. 9 and 10, an air blowing unit 10B is different in that it includes a control module 20B, a temperature sensor 41, and a temperature sensor 42. The other configuration of the air blowing unit 10B is the same as that of the air blowing unit 10A, and description of the same portions is omitted.

The air blowing unit 10B includes the temperature sensor 41 and the temperature sensor 42. The temperature sensor 41 and the temperature sensor 42 are, for example, chip-type thermistors similar to the temperature sensor 40. The temperature sensor 41 and the temperature sensor 42 are disposed in or on the first tube 161 of the flow passage tube 16 of the air blowing unit 10B. The temperature sensor 41 is disposed in the vicinity of the other open end (tip) of the first tube 161. The temperature sensor 42 is disposed in the vicinity of the one open end (end on the air blowing device 12 side) of the first tube 161.

In such a configuration, when the user 90 wears the air blowing unit 10B, the temperature sensor 41 is disposed inside the ear canal opening 910, and the temperature sensor 42 is disposed outside the ear canal opening 910 at a position distant from the ear canal opening 910.

The temperature sensor 41 and the temperature sensor 42 output the temperature detection signals to the control module 20B.

The control module 20B includes a core body temperature detection section 24B. The core body temperature detection section 24B detects the core body temperature of the user 90 on the basis of the temperature detection signal of the temperature sensor 41 and the temperature detection signal of the temperature sensor 42.

The air blowing control section 22 generates and outputs the air blowing control signal on the basis of the core body temperature. For example, when detecting that the core body temperature is greater than or equal to a threshold for cooling, the air blowing control section 22 generates the air blowing control signal and outputs it to the air blowing device 12.

Thus, the air blowing unit 10B can cool the user 90 by blowing air when the core body temperature of the user 90 becomes high. At this time, the air blowing device 12 delivers airflow to the ear canal opening 910 and thus can effectively cool the user 90.

### FOURTH EMBODIMENT

An air blowing unit according to a fourth embodiment of the present disclosure is described with reference to the drawings. FIG. 11 is a schematic configuration diagram of a temperature sensor of the air blowing unit according to the fourth embodiment. FIG. 12 is an enlarged cross-sectional view of a vicinity of a wearing position of the air blowing unit according to the fourth embodiment.

The air blowing unit according to the fourth embodiment is different from the air blowing unit according to the second embodiment in that it includes a temperature sensor 40C. The other configuration of the air blowing unit according to the fourth embodiment is the same as that of the air blowing unit 10A according to the second embodiment, and description of the same portions is omitted.

As depicted in FIG. 11, the temperature sensor 40C includes a base portion 401, a plurality of thermistors 4021 to 4024, and a plurality of wiring patterns 4031 to 4034. The base portion 401 is formed of an insulating film that has flexibility and is deformable. The base portion 401 has an elongated shape.

The thermistors 4021 to 4024 are disposed at intervals in the extension direction of the base portion 401. The wiring patterns 4031 to 4034 are connected to the thermistors 4021 to 4024, respectively. The wiring patterns 4031 to 4034 are connected to the thermistors 4021 to 4024 in a connection manner that enables extraction of temperature detection signals of the thermistors 4021 to 4024, although depiction is omitted.

The temperature sensor 40C is disposed in or on the ear pad 102. Thus, the thermistors 4021 to 4024 of the temperature sensor 40C abut against or are brought close to a wall surface of the external auditory canal 911. Accordingly, the temperature detection signals of the thermistors 4021 to 4024 reflect the body temperature of the user 90 with higher accuracy.

The temperature detection signals of the thermistors 4021 to 4024 are inputted to the body temperature detection section 23. The body temperature detection section 23 detects the body temperature of the user 90 on the basis of the temperature detection signals of the thermistors 4021 to 4024.

In this manner, the air blowing unit according to the fourth embodiment can achieve operation and effects similar to those of the air blowing unit 10A according to the second embodiment. Further, the air blowing unit according to the fourth embodiment can detect the body temperature with high accuracy, and thus execute air blowing control based on the body temperature of the user 90 with high accuracy.

### Example of Activation Circuit of Air Blowing Control Section

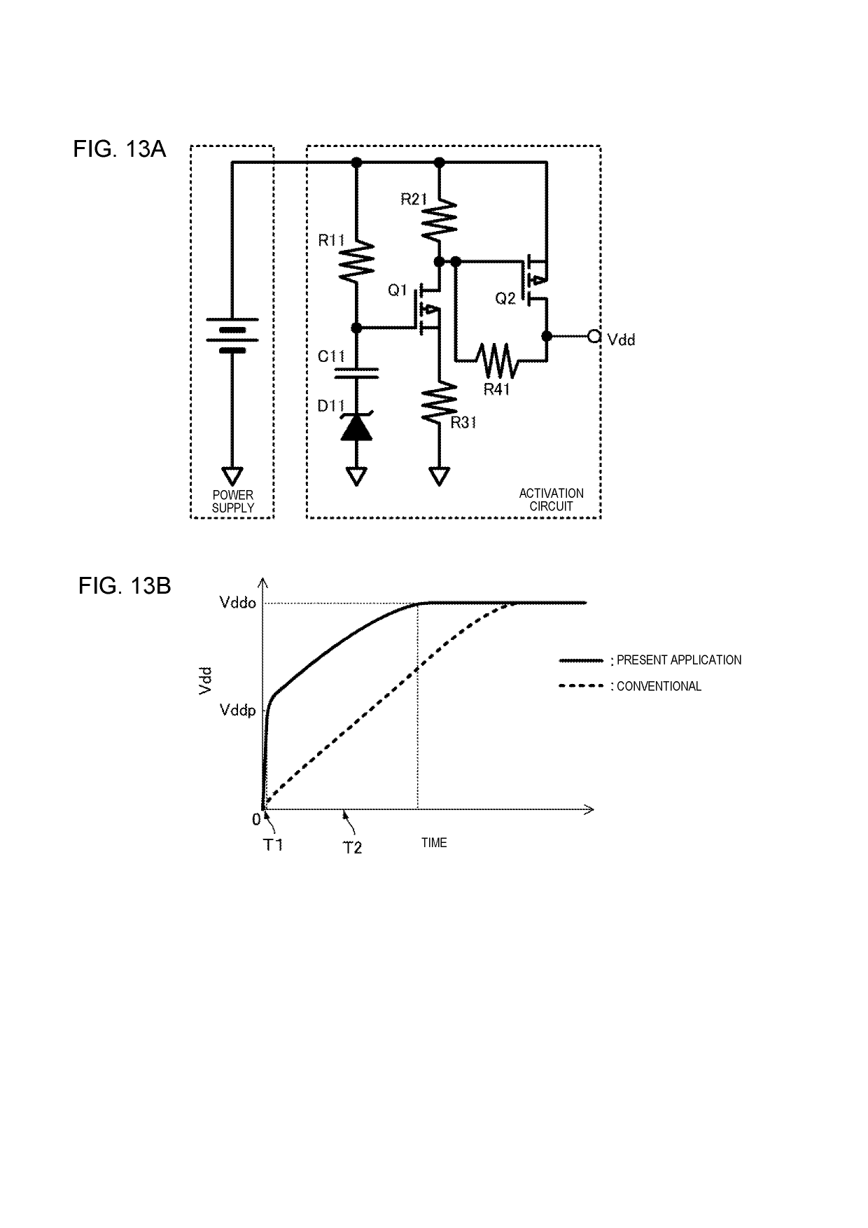

FIG. 13A is a circuit diagram depicting an example of an activation circuit of the air blowing control section. FIG. 13B depicts an output voltage characteristic of the activation circuit. The horizontal axis in FIG. 13B indicates an elapsed time from the start of driving (activation), and the vertical axis indicates an output voltage. This output voltage is the voltage that corresponds to the voltage of the air blowing control signal and is applied to the air blowing device.

As depicted in FIG. 13A, the activation circuit includes a plurality of switching elements Q1 and Q2, a plurality of resistors R11, R21, R31, and R41, a capacitor C11, and a Zener diode D11.

A series circuit of the resistor R11, the capacitor C11, and the Zener diode D11 is connected between the positive electrode and the negative electrode of a DC power supply. The gate terminal of the switching element Q1 is connected to a node between the resistor R11 and the capacitor C11.

The resistor R21 is connected to the positive electrode of the DC power supply. The drain terminal of the switching element Q1 is connected to the resistor R21. The resistor R31 is connected to the source terminal of the switching element Q1, and the resistor R31 is connected to the negative electrode of the DC power supply. The gate terminal of the switching element Q2 is connected to a node between the resistor R21 and the drain terminal of the switching element Q1. The drain terminal of the switching element Q2 is connected to the positive electrode of the DC power supply. The source terminal of the switching element Q2 is connected to an output terminal of the activation circuit. The source terminal of the switching element Q2 is connected to the gate terminal of the switching element Q2 through the resistor R41.

As depicted in FIG. 13B, the activation circuit having such a configuration can execute slope voltage control in which a voltage change rate in a voltage (activation voltage) at the start of generation of a supply voltage Vdd is set to a first stage and a second stage and the voltage change rate of the second stage is set lower than that of the first stage.

Thus, the activation circuit can suppress undesired power consumption at the time of activation, and increase the efficiency of power supply to the air blowing device configured with the piezoelectric pump.

The activation circuit is not limited to that shown as the example, and may be a circuit that controls the supply voltage Vdd by an MCU.

### Example of Drive Circuit of Air Blowing Control Section

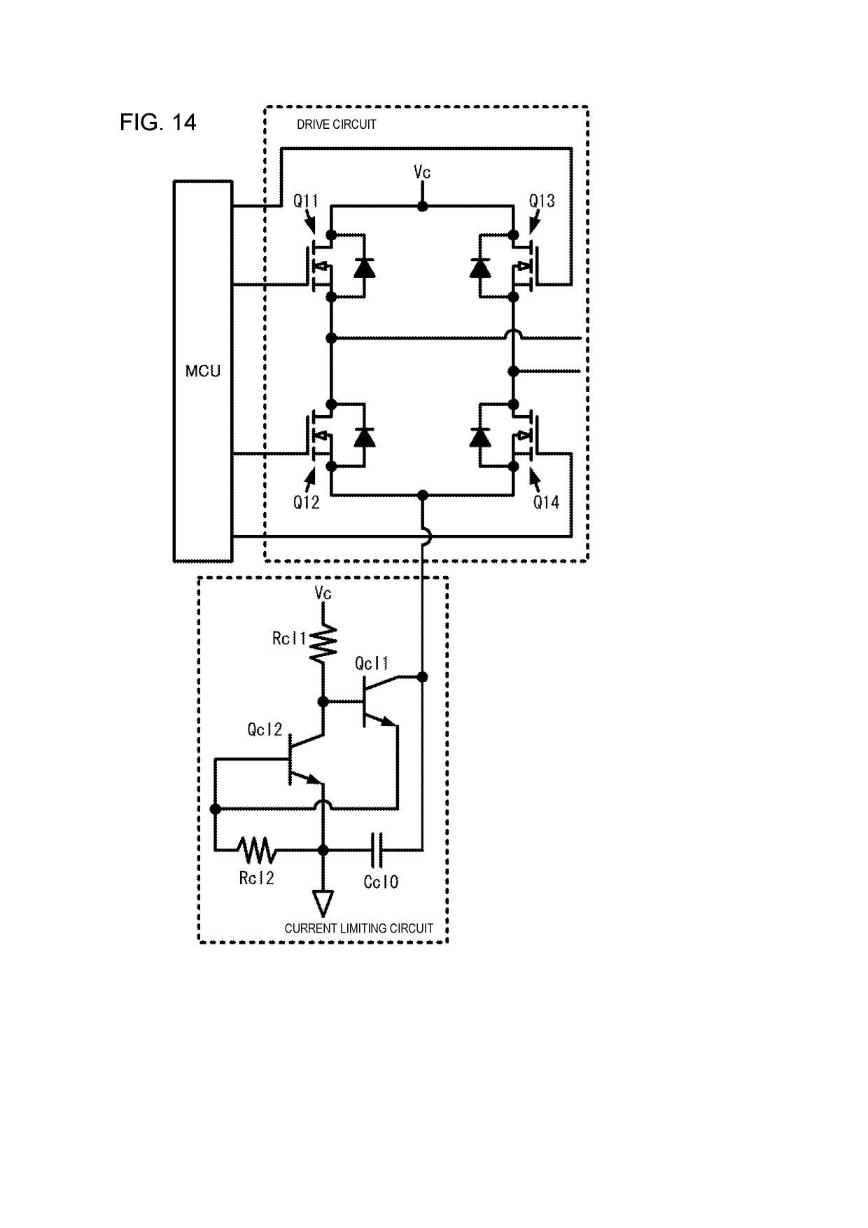

FIG. 14 is a circuit diagram depicting an example of a drive circuit of the air blowing control section.

As depicted in FIG. 14, the drive circuit of the example includes an H-bridge circuit controlled by an MCU and a current limiting circuit. The MCU is connected to the H-bridge circuit and outputs a PWM signal having appropriate frequency and duty ratio. The H-bridge circuit includes a plurality of switching elements Q11 to Q14. The respective gate terminals of the switching elements Q11 to Q14 are connected to the MCU. The drain terminal of the switching element Q11 and the drain terminal of the switching element Q13 are connected, and a drive voltage Vc is applied thereto. The source terminal of the switching element Q11 is connected to the drain terminal of the switching element Q12. The source terminal of the switching element Q13 is connected to the drain terminal of the switching element Q14. The source terminal of the switching element Q12 and the source terminal of the switching element Q14 are connected, and this connection node is connected to the current limiting circuit. The connection node between the source terminal of the switching element Q11 and the drain terminal of the switching element Q12 and the connection node between the source terminal of the switching element Q13 and the drain terminal of the switching element Q14 serve as output terminals of the drive circuit.

The current limiting circuit includes a transistor Qcl1, a transistor Qcl2, a resistor Rcl1, a resistor Rcl2, and a capacitor Ccl0.

The drive voltage Vc is applied to the base terminal of the transistor Qcl1 through the resistor Rcl1. This drive voltage Vc is the supply voltage Vdd indicated in FIG. 13A. The base terminal of the transistor Qcl1 is connected to the collector terminal of the transistor Qcl2. The emitter terminal of the transistor Qcl2 is connected to a reference potential.

The collector terminal of the transistor Qcl1 is connected to the reference potential through the capacitor Ccl0. Further, the collector terminal of the transistor Qcl1 is connected to the connection node between the source terminal of the switching element Q12 and the source terminal of the switching element Q14.

The emitter terminal of the transistor Qcl1 is connected to the base terminal of the transistor Qcl2. The connection node between the base terminal of the transistor Qcl2 and the emitter terminal of the transistor Qcl1 is connected to the reference potential through the resistor Rcl2.

With such a configuration, the drive circuit and the current limiting circuit can set the drive voltage such that the air blowing device is driven for an airflow volume giving optimal power consumption and can suppress supply of an undesired current to the air blowing device. Thus, the drive circuit and the current limiting circuit can optimize the power consumption of the air blowing device configured with the piezoelectric pump, and increase the air blowing efficiency.

The drive circuit is not limited to that shown as the example, and may employ another circuit configuration, such as one configured with a linear amplifier.

### Example of VR Apparatus Using Air Blowing Unit

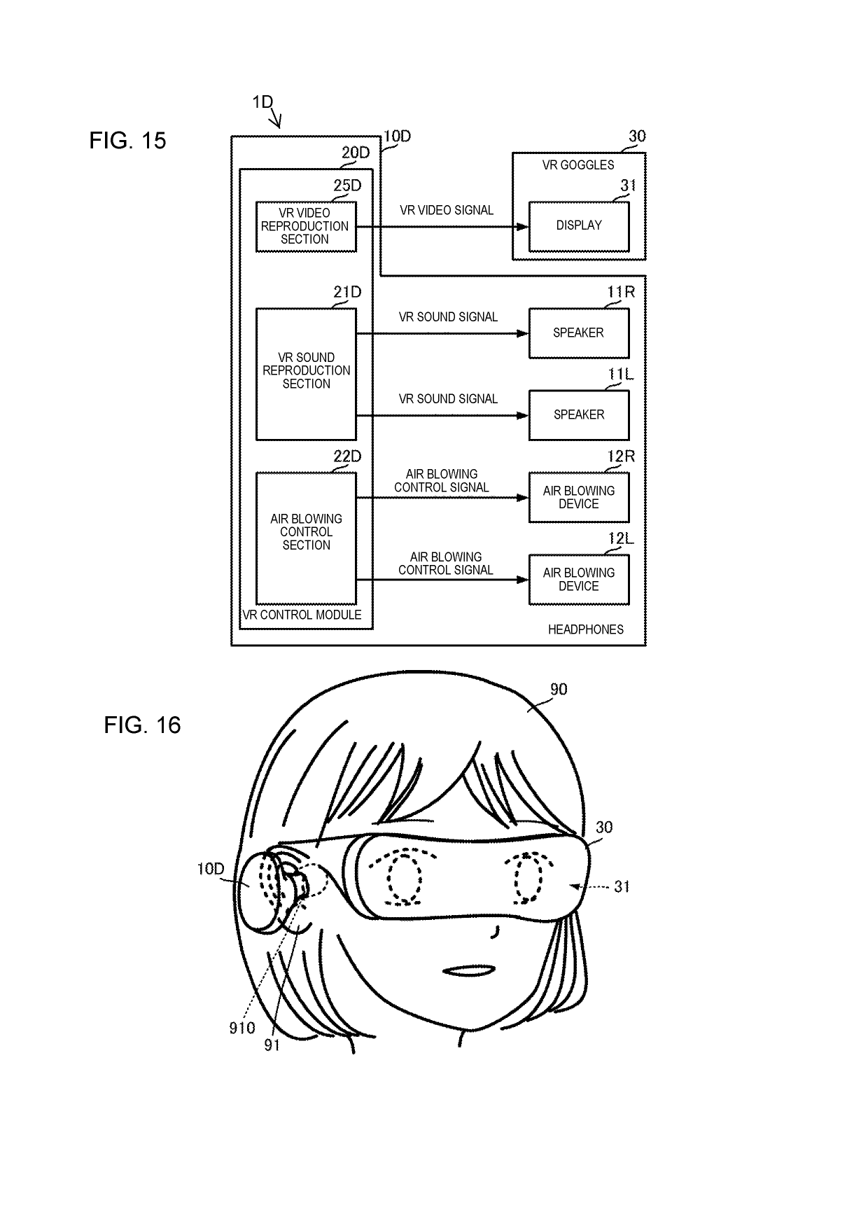

FIG. 15 is a functional block diagram of a VR apparatus using an air blowing unit. FIG. 16 is a diagram depicting an example of how the VR apparatus is worn.

### Configuration of Functional Portions of VR Apparatus 1D

As depicted in FIG. 15, a VR apparatus 1D includes an air blowing unit 10D and VR goggles 30. The air blowing unit 10D includes a speaker 11R, a speaker 11L, an air blowing device 12R, an air blowing device 12L, and a VR control module 20D. In the present embodiment, a configuration in which the VR control module 20D is included in the air blowing unit 10D is depicted. However, the VR control module 20D may be included in the VR goggles 30, or may be provided separately from the air blowing unit 10D and the VR goggles 30, or in the cloud or the like.

The speaker 11R is for the right channel, and the speaker 11L is for the left channel. The air blowing device 12R is for the right ear, and the air blowing device 12L is for the left ear.

The air blowing unit 10D includes a right-ear air blowing unit and a left-ear air blowing unit, although detailed depiction is omitted. The speaker 11R and the air blowing device 12R are included in the right-ear air blowing unit, and the speaker 11L and the air blowing device 12L are included in the left-ear air blowing unit.

The VR control module 20D includes a VR sound reproduction section 21D, an air blowing control section 22D, and a VR video reproduction section 25D. The VR video reproduction section 25D reproduces a VR video signal and outputs it to a display 31 of the VR goggles 30. The VR sound reproduction section 21D reproduces a VR sound signal corresponding to the above-described sound radiation control signal and outputs it to the speaker 11R and the speaker 11L. The air blowing control section 22D generates an air blowing control signal and outputs it to the air blowing device 12R and the air blowing device 12L.

The VR video reproduction section 25D, the VR sound reproduction section 21D, and the air blowing control section 22D output the VR video signal, the VR sound signal, and the air blowing control signal in time synchronization on the basis of virtual reality (VR) provided to a user who uses the VR apparatus 1D.

The display 31 displays VR video based on the VR video signal. The speaker 11R and the speaker 11L generate sound based on the VR sound signal. The air blowing device 12R and the air blowing device 12L are driven on the basis of the air blowing control signal to generate airflow.

As depicted in FIG. 16, the air blowing unit 10D of such a VR apparatus 1D is worn on both ears of the user 90. The right-ear air blowing unit of the air blowing unit 10D is worn on the right ear, and although depiction is omitted, the left-ear air blowing unit of the air blowing unit 10D is worn on the left ear. The VR goggles 30 are worn so as to cover the eyes of the user 90.

This allows the user 90 to view the VR video by the display 31 of the VR goggles 30. Further, by the air blowing unit 10D, the user 90 can hear the sound with both ears and feel the airflow with both ears.

In this manner, the VR apparatus 1D can provide the user with the airflow in addition to the video and the sound. Further, the VR apparatus 1D can provide the airflow in time synchronization, in addition to the time synchronization of the video and the sound. That is, the VR apparatus 1D can cause the user to experience VR not only through the visual sense and the auditory sense of the user but also through the tactile sense thereof. Thus, the VR apparatus 1D can provide a high sense of immersion to the user.

For example, the VR control module 20D outputs the air blowing control signal in time synchronization with the VR video signal and the VR sound signal at, in virtual reality, a timing of providing cool-feeling video and sound to the user, a timing of providing video and sound that give a surprise to the user, or a timing of providing video and sound that cause the user to have a sense of fear. This allows the user to experience coolness, surprise, or fear by not only the video and the sound but also airflow.

In this case, because the speaker 11R, the speaker 11L, the air blowing device 12R, and the air blowing device 12L are included in the air blowing unit 10D, the VR apparatus 1D can be made compact. Thus, the user 90 can readily experience virtual reality with a high sense of immersion with simple equipment.

Moreover, because the speaker 11R, the speaker 11L, the air blowing device 12R, and the air blowing device 12L are included in the air blowing unit 10D, the sound radiation sources and the air blowing sources are close to the ears (user 90). Accordingly, a time difference between the arrival of the sound at the ears and the arrival of the airflow at the ears is unlikely to occur. Thus, the VR apparatus 1D can provide a higher sense of immersion to the user 90.

### Derivative Examples of Air Blowing Unit

In the above modes, the earphone-type air blowing units partly inserted into the ear canal opening 910 of the user 90 have been described as examples. However, it is also possible to use a headphone-type air blowing unit that covers the ear.

### Structural Example of Headphone-type Air Blowing Unit 10E1

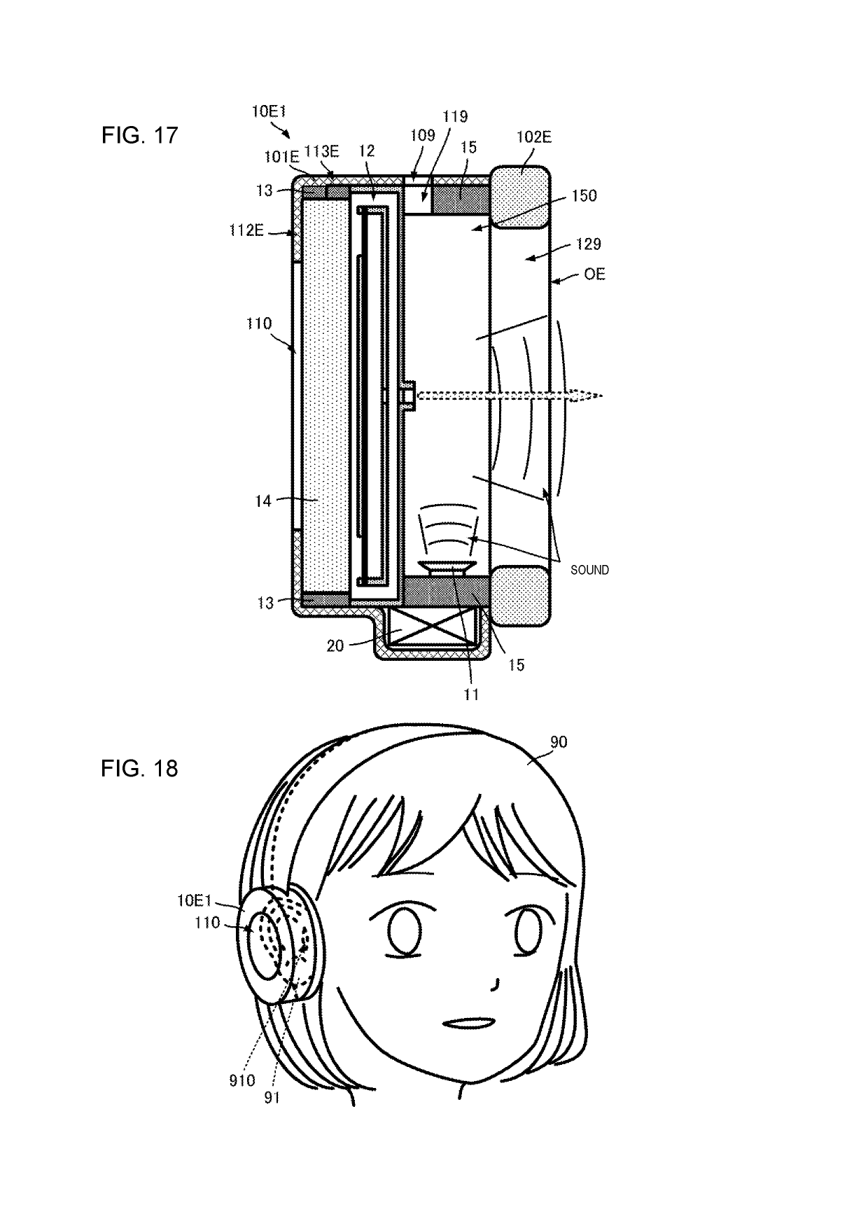

FIG. 17 is a side cross-sectional view depicting an example of a configuration of a headphone-type air blowing unit. FIG. 18 is a diagram depicting an example of how the headphone-type air blowing unit is worn.

As depicted in FIG. 17, an air blowing unit 10E1 includes a housing 101E, the speaker 11, the air blowing device 12, the first sound absorbing member 13, the second sound absorbing member 14, a holding member 15, and an ear pad 102E.

The housing 101E has a cylindrical shape having a bottom wall 112E and a side wall 113E. The housing 101E is open at an end portion on the side opposite to the bottom wall 112E in the axial direction of the cylindrical shape. The opening 110 having a predetermined opening area is formed in the bottom wall 112E. The housing 101E is composed of a material having rigidity that allows the shape to be kept constant, and is composed of, for example, a resin, a metal, or the like.

The ear pad 102E has an annular shape. The ear pad 102E is composed of a material having cushioning properties.

The ear pad 102E has the central space 129. The ear pad 102E is attached to the housing 101E such that the central space 129 communicates with the opening of the housing 101E. The opening surface of the ear pad 102E on the side opposite to the mounting surface to the housing 101E is the opening OE of the air blowing unit 10E1. The opening OE serves as a sound radiation surface and an airflow delivery surface as the air blowing unit 10E1.

The air blowing device 12 is disposed in the housing 101E such that the front thereof is oriented toward the opening OE. Further, the air blowing device 12 is disposed at such a position that the opening OE and the discharge port 1239 overlap each other when the opening OE is viewed from the outer side.

The first sound absorbing member 13 is disposed on the bottom wall 112E side of the housing 101E relative to the air blowing device 12. In other words, the first sound absorbing member 13 is disposed on the side opposite to the opening OE with the air blowing device 12 being a reference in the housing 101E.

The first sound absorbing member 13 abuts against the bottom wall 112E and the side wall 113E. A surface of the first sound absorbing member 13 on the side opposite to the bottom wall 112E abuts against the back surface of the air blowing device 12.

The second sound absorbing member 14 is disposed in a through-hole penetrating the first sound absorbing member 13. The second sound absorbing member 14 overlaps the opening 110 of the bottom wall 112E of the air blowing unit 10E1.

The holding member 15 has an annular shape and is composed of a material having predetermined rigidity. The holding member 15 may be composed of a material having low sound reflectivity.

The holding member 15 abuts against the inner peripheral surface of the side wall 113E of the housing 101E. The holding member 15 is disposed between the air blowing device 12 and the ear pad 102E in the axial direction of the housing 101E. An auxiliary air-discharge hole 119 is formed in the holding member 15. The auxiliary air-discharge hole 119 communicates with the outside of the housing 101E through a through-hole 109 formed in the side wall 113E of the housing 101E.

The speaker 11 is fixed to the holding member 15. Specifically, the speaker 11 is disposed such that a sound radiation surface thereof faces a central space of the holding member 15 and is exposed to this central space.

A main sound radiation direction of the speaker 11 is orthogonal to the axial direction of the housing 101E. The manner in which the speaker 11 is disposed is not limited thereto as long as the speaker 11 does not overlap the discharge port 1239 of the air blowing device 12 as viewed from the opening OE.

As depicted in FIG. 18, such an air blowing unit 10E1 is worn on the head of the user 90 and used. The air blowing unit 10E1 is worn so as to cover both ears of the user 90.

Such a configuration allows the air blowing unit 10E1 to achieve operation and effects similar to those of the air blowing unit 10.

### Structural Example of Headphone-type Air Blowing Unit 10E2

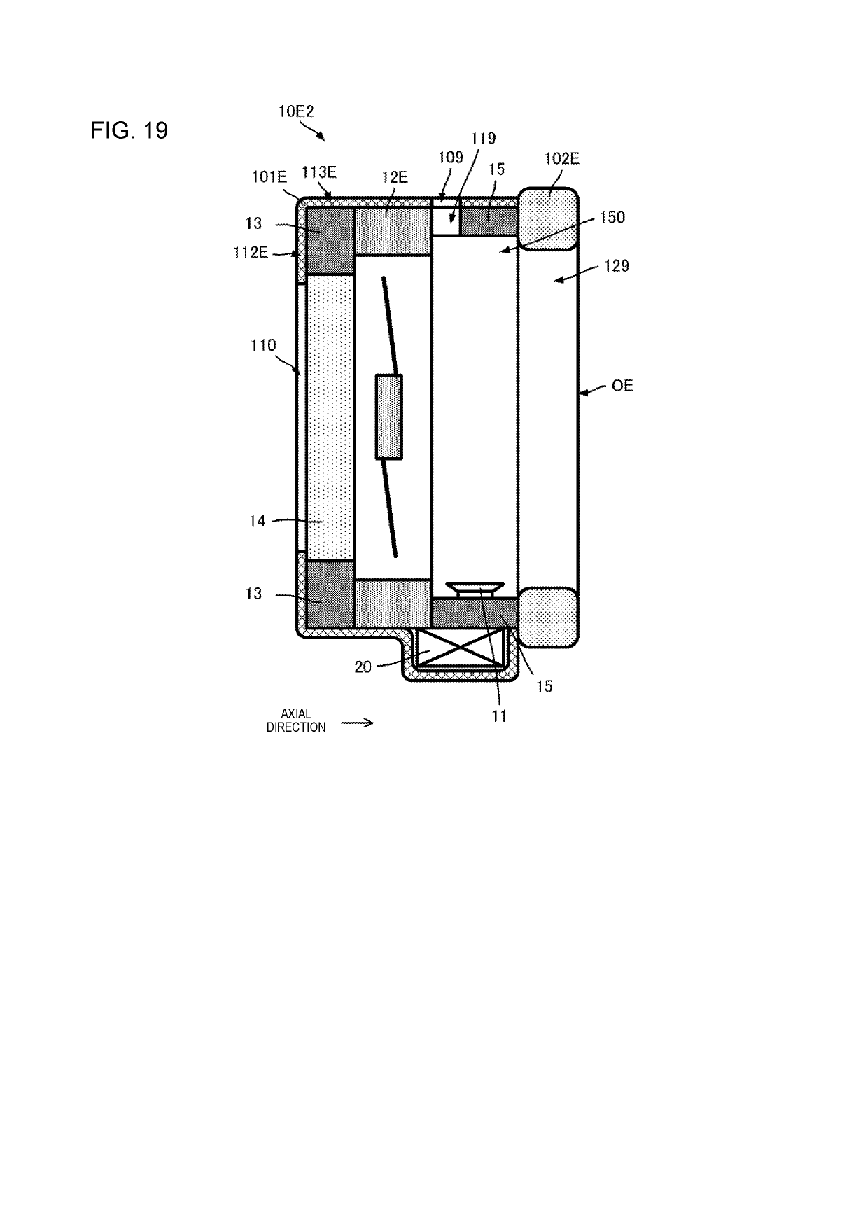

FIG. 19 is a side cross-sectional view depicting an example of a configuration of a headphone-type air blowing unit. As depicted in FIG. 19, an air blowing unit 10E2 is different from the air blowing unit 10E1 in that it includes an air blowing device 12E. The other configuration of the air blowing unit 10E2 is the same as that of the air blowing unit 10E1, and description of the same portions is omitted.

The air blowing device 12E is configured with an axial flow fan. The air blowing device 12E is disposed such that an air blowing surface thereof is substantially orthogonal to the axial direction of a housing.

Such a configuration allows the air blowing unit 10E2 to achieve operation and effects similar to those of the air blowing unit 10E1.

The configurations of the above respective embodiments can be combined as appropriate, and operation and effects corresponding to each combination can be achieved.

<1> An air blowing unit comprising: a housing having a first opening capable of communicating with an ear canal opening of a user; an air blowing device that is provided in the housing and generates a gas to be delivered from the first opening to outside of the housing; and a speaker that is provided in the housing and generates sound to be delivered from the first opening to the outside of the housing, wherein a discharge port of the air blowing device is disposed at a position overlapping the first opening when the first opening is viewed from the outside, the speaker is disposed at a position that is present on the first opening side relative to the air blowing device and does not overlap the discharge port as viewed from an outer side of the first opening, and a main sound radiation direction of the speaker is a direction different from a direction connecting the position of the speaker and the first opening.

<2> The air blowing unit according to <1>, further comprising: a flow passage tube disposed in the housing, the gas and the sound being propagated through the flow passage tube, wherein the flow passage tube includes a first tube and a second tube, a first end that is one end of the first tube abuts against and communicates with the discharge port of the air blowing device, and a second end that is the other end of the first tube is close to the first opening, and a third end that is one end of the second tube abuts against or is close to a sound radiation surface of the speaker, and a fourth end that is the other end of the second tube communicates with an internal space of the first tube.

<3> The air blowing unit according to <1> or <2>, wherein the air blowing device is a piezoelectric pump using a piezoelectric element.

<4> The air blowing unit according to any one of <1> to <3>, further comprising: an air blowing control section configured to generate and output an air blowing control signal of the air blowing device.

<5> The air blowing unit according to <4>, further comprising: a temperature sensor that detects a body temperature of the user, wherein the air blowing control section is configured to output the air blowing control signal with reference to the body temperature detected by the temperature sensor.

<6> The air blowing unit according to <5>, wherein the temperature sensor detects a core body temperature as the body temperature.

<7> The air blowing unit according to any one of <5> to <6>, wherein the temperature sensor includes a base portion that is deformable.

<8> The air blowing unit according to any one of <4> to <7>, wherein the air blowing control section is configured to execute slope voltage control in which a voltage change rate is set to a first stage and a second stage at a start of generation of the air blowing control signal and the voltage change rate of the second stage is set lower than the voltage change rate of the first stage.

<9> The air blowing unit according to any one of <4> to <8>, wherein the air blowing control section is configured to include a current limiting circuit that limits an output current.

<10> The air blowing unit according to any one of <1> to <9>, further comprising: a fixing member disposed on a side opposite to the first opening with the air blowing device being a reference in the housing, the fixing member fixing the air blowing device to the housing, wherein the fixing member includes a first sound absorbing member in which air permeability is low and sound absorbing properties are high, and a second sound absorbing member that is disposed in a through-hole penetrating the first sound absorbing member and has the sound absorbing properties, the air permeability of the second sound absorbing member being high.

<11> A VR apparatus comprising: the air blowing unit according to any one of <4> to <10>; and a VR control module configured to include the air blowing control section and, on a basis of virtual reality provided to the user, output a drive signal to the air blowing device and output a sound radiation control signal to the speaker.

<12> The VR apparatus according to <11>, further comprising: a display that displays video based on the virtual reality provided to the user, wherein the VR control module is configured to output a video signal to the display.

10, 10A, 10B, 10D, 10E1, 10E2 air blowing units

1D VR apparatus

11, 11L, 11R speakers

12, 12E, 12L, 12R air blowing devices

13 first sound absorbing member

14 second sound absorbing member

15 holding member

16 flow passage tube

20, 20A, 20B control modules

20D VR control module

21 sound reproduction section

21D VR sound reproduction section

22, 22D air blowing control sections

23 body temperature detection section

24B core body temperature detection section

25D VR video reproduction section

30 VR goggles

31 display

40, 40C, 41, 42 temperature sensors

90 user

91 ear

101, 101E housings

102, 102E ear pads

109 through-hole

110 opening

112, 112E bottom walls

113, 113E side walls

114 cylindrical portion

119 auxiliary air-discharge hole

123 outer housing

124 inner housing

125 diaphragm

126 piezoelectric element

129 central space

161 first tube

162 second tube

401 base portion

910 ear canal opening

911 external auditory canal

1230 flow passage

1239 discharge port

1249 through-hole

1290 pump chamber

4021 thermistor

4031 wiring pattern

1. An air blowing unit comprising:
a housing having a first opening configured to communicate with an ear canal opening of a user;
an air blowing device provided in the housing and configured to generate a gas to be delivered from the first opening to outside of the housing; and
a speaker provided in the housing and configured to generate sound to be delivered from the first opening to the outside of the housing, wherein
a discharge port of the air blowing device is disposed at a position overlapping the first opening when the first opening is viewed from the outside,
the speaker is disposed at a position present on the first opening side relative to the air blowing device and not overlapping the discharge port as viewed from an outer side of the first opening, and
a main sound radiation direction of the speaker is a direction different from a direction connecting the position of the speaker and the first opening.

2. The air blowing unit according to claim 1, further comprising:
a flow passage tube disposed in the housing, the gas and the sound being propagated through the flow passage tube, wherein
the flow passage tube includes a first tube and a second tube,
a first end being one end of the first tube abuts against and communicates with the discharge port of the air blowing device, and a second end being another end of the first tube is close to the first opening, and
a third end being one end of the second tube abuts against or is close to a sound radiation surface of the speaker, and a fourth end being another end of the second tube communicates with an internal space of the first tube.

3. The air blowing unit according to claim 1, wherein
the air blowing device is a piezoelectric pump using a piezoelectric element.

4. The air blowing unit according to claim 1, further comprising:
an air blowing control section configured to generate and output an air blowing control signal of the air blowing device.

5. The air blowing unit according to claim 4, further comprising:
a temperature sensor configured to detect a body temperature of the user, wherein
the air blowing control section is configured to output the air blowing control signal with reference to the body temperature detected by the temperature sensor.

6. The air blowing unit according to claim 5, wherein
the temperature sensor is configured to detect a core body temperature as the body temperature.

7. The air blowing unit according to claim 5, wherein
the temperature sensor includes a deformable base portion.

8. The air blowing unit according to claim 4, wherein
the air blowing control section is configured to execute slope voltage control in which a voltage change rate is set to a first stage and a second stage at a start of generation of the air blowing control signal and the voltage change rate of the second stage is set lower than the voltage change rate of the first stage.

9. The air blowing unit according to claim 4, wherein
the air blowing control section includes a current limiting circuit configured to limit an output current.

10. The air blowing unit according to claim 1, further comprising:
a fixing member disposed on a side opposite to the first opening with the air blowing device being a reference in the housing, the fixing member fixing the air blowing device to the housing, wherein
the fixing member includes
a first sound absorbing member having low air permeability and high sound absorbing properties, and
a second sound absorbing member disposed in a through-hole penetrating the first sound absorbing member and having the sound absorbing properties, the air permeability of the second sound absorbing member being high.

11. A VR apparatus comprising:
the air blowing unit according to claim 4; and
a VR control module includes the air blowing control section and, on a basis of virtual reality provided to the user, configured to output a drive signal to the air blowing device and output a sound radiation control signal to the speaker.

12. The VR apparatus according to claim 11, further comprising:
a display configured to display video based on the virtual reality provided to the user, wherein
the VR control module is configured to output a video signal to the display.

13. The air blowing unit according to claim 2, wherein
the air blowing device is a piezoelectric pump using a piezoelectric element.

14. The air blowing unit according to claim 2, further comprising:
an air blowing control section configured to generate and output an air blowing control signal of the air blowing device.

15. The air blowing unit according to claim 3, further comprising:
an air blowing control section configured to generate and output an air blowing control signal of the air blowing device.

16. The air blowing unit according to claim 6, wherein
the temperature sensor includes a deformable base portion.

17. The air blowing unit according to claim 5, wherein
the air blowing control section is configured to execute slope voltage control in which a voltage change rate is set to a first stage and a second stage at a start of generation of the air blowing control signal and the voltage change rate of the second stage is set lower than the voltage change rate of the first stage.

18. The air blowing unit according to claim 6, wherein
the air blowing control section is configured to execute slope voltage control in which a voltage change rate is set to a first stage and a second stage at a start of generation of the air blowing control signal and the voltage change rate of the second stage is set lower than the voltage change rate of the first stage.

19. The air blowing unit according to claim 7, wherein
the air blowing control section is configured to execute slope voltage control in which a voltage change rate is set to a first stage and a second stage at a start of generation of the air blowing control signal and the voltage change rate of the second stage is set lower than the voltage change rate of the first stage.

20. The air blowing unit according to claim 5, wherein
the air blowing control section includes a current limiting circuit configured to limit an output current.
